(19) United States
(12) Patent Application Publication
(10) Pub. No.: US 2003/0030852 A1
(43) Pub. Date: Feb. 13, 2003

(54) Digital visual recording content indexing and packaging

(75) Inventors: Harold G. Sampson, Sunnyvale, CA (US); Sharleen Reyes, San Jose, CA (US)

Correspondence Address: David R Grahm, 1337 Chewpon Avenue, Milpitas, CA, 95035, US

(73) Assignee: YesVideo, Inc.

(21) Appl. No.: 10/198,007

(22) Filed: Jul. 17, 2002

Related U.S. Application Data
(60) Provisional application No. 60/306,275, filed on Jul. 17, 2001.

(51) Int. Cl. H04N 1/04

(52) U.S. Cl. 358/479

(57) ABSTRACT

Digital visual recording content is indexed and packaged in a manner that facilitates identification of, and navigation through, the digital visual recording content by a viewer. In particular, keyframe displays are presented to a viewer in a manner that facilitates navigation through the digital video content by the viewer. In one aspect of the invention, keyframes are displayed on a visual display device. In another aspect of the invention, keyframes are displayed as part of a video disk package.

### BACKGROUND OF THE INVENTION

1. Field of the Invention

This invention relates to digital visual recording content (e.g., digital video content) and, in particular, to indexing and/or packaging of digital visual recording content in a manner that facilitates identification of, and/or navigation through, the digital visual recording content by a viewer.

2. Related Art

A variety of media can be used to store visual recording content. In particular, visual recording content is now often stored in digital form on digital data storage media (CDs, DVDs). Storing visual recording content in digital form has enabled more flexible navigation among the visual recording content. However, it can still be difficult to easily and rapidly locate a section of visual recording content that it is desired to view.

### SUMMARY OF THE INVENTION

In accordance with the invention, digital visual recording content (e.g., digital video content) is divided into a multiplicity of digital visual recording segments (e.g., scenes, DVD chapters) that are each represented by a digital visual recording frame (a keyframe), the collection of keyframes comprising an index of the digital visual recording content in which each keyframe is an index entry. According to the invention, the digital visual recording content can be indexed and/or packaged in a manner that facilitates identification of, and/or navigation through, the digital visual recording content by a viewer.

In one embodiment of the invention, a video content index display includes a keyframe display region that includes a multiplicity of keyframe displays, each keyframe display corresponding to a video segment of digital video content and being denoted by indicia (e.g., one or more numbers or letters, or a time and/or date) that identifies the keyframe display and the corresponding video segment. The indicia can also indicate a corresponding input to a user control apparatus that begins display on a visual display device of the video segment corresponding to the keyframe display. The video content index display can further include a menu region including a multiplicity of page identification displays, each page identification display identifying a page of keyframe displays. Visual recording data representing the digital video content, and instructions and/or data for producing the video content index display can be encoded together on a data storage medium or media, such as one or more DVDs or CDs.

In another embodiment of the invention, a video disk package for housing a video disk when the video disk is not in use includes a keyframe index that includes a multiplicity of keyframe displays, each keyframe display corresponding to a video segment of digital video content and being denoted by indicia (e.g., one or more numbers or letters, or a time and/or date) that identifies the keyframe display and the corresponding video segment. The indicia can also indicate a corresponding input to a user control apparatus that begins display on a visual display device of the video segment corresponding to the keyframe display. The keyframe index can be formed on a keyframe index sheet that is included with the video disk package or the keyframe index can be formed as part of a case used to house the video disk when not in use. The video disk can be one or more DVDs or CDs on which visual recording data representing the digital video content is encoded.

In still another embodiment of the invention, a system for facilitating navigation of digital video content includes: 1) a video content index display including a keyframe display region that includes a multiplicity of keyframe displays, each keyframe display being denoted in the video content index display by indicia (e.g., one or more numbers or letters, or a time and/or date) that identifies the keyframe display, and 2) a video disk package for housing a video disk when the video disk is not in use, the video disk package including a keyframe index that includes a multiplicity of keyframe displays, each keyframe display being denoted in the video disk package keyframe index by the same indicia used to denote that keyframe display in the video content index display. Each keyframe display can correspond to a video segment of the digital video content and each of the indicia denoting a keyframe display can indicate the corresponding video segment. The indicia can also indicate a corresponding input to a user control apparatus that begins display on a visual display device of the video segment corresponding to the keyframe display. The video content index display can further include a menu region including a multiplicity of page identification displays, each page identification display identifying a page of keyframe displays. The keyframe index can be formed on a keyframe index sheet that is included with the video disk package or the keyframe index can be formed as part of a case used to house the video disk when not in use. Visual recording data representing the digital video content, and instructions and/or data for producing the video content index display can be encoded together on the video disk, which can be one or more DVDs or CDs.

In yet another embodiment of the invention, video segments and corresponding keyframes are identified in digital video content (which can be stored on a video disk) by first ascertaining a specified number of video segments and corresponding keyframes to be identified in the digital video content, then modifying a previously determined set of video segments and corresponding keyframes in the digital video content to produce a new set of video segments and corresponding keyframes in the digital video content, such that the new set of video segments and corresponding keyframes includes the specified number of video segments and corresponding keyframes. The new set of video segments and corresponding keyframes can be produced by adding or eliminating one or more video segments and corresponding keyframes to the previously determined set of video segments and corresponding keyframes. Modification of the previously determined set of video segments and corresponding keyframes to produce the new set of video segments and corresponding keyframes can be performed automatically after determination of the previously determined set of video segments and corresponding keyframes. A keyframe index can be created for inclusion as part of a video disk package for housing a video disk on which the digital video content is stored when the digital video content is not in use, the keyframe index including keyframe displays produced from the new set of keyframes. The new set of keyframes can be grouped in a multiplicity of pages that each include a multiplicity of keyframes, none of which are included in another page.

In another embodiment of the invention, navigation of digital video content (which can be stored on a video disk) is facilitated, where a multiplicity of keyframes have been defined that each correspond to a video segment of the digital video content, by displaying a first multiplicity of keyframe displays, ascertaining an input to a user control apparatus intended to effect movement of the position of a highlighting display mechanism from a keyframe display located at an edge of the first multiplicity of keyframe displays, and displaying a second multiplicity of keyframe displays in response to the input, the second multiplicity of keyframe displays including one or more keyframe displays not included in the first multiplicity of keyframe displays. In a further particular embodiment, none of the keyframe displays of the second multiplicity of keyframe displays is included in the first multiplicity of keyframe displays. In another further particular embodiment, at least one of the keyframe displays of the first multiplicity of keyframe displays is included in the second multiplicity of keyframe displays, and at least one of the keyframe displays of the second multiplicity of keyframe displays is not included in the first multiplicity of keyframe displays. The first multiplicity of keyframe displays can be arranged in a rectangular array.

In still another embodiment of the invention, a video content index display includes a keyframe display region that includes a multiplicity of keyframe displays, each keyframe display corresponding to a video segment of digital video content, and the keyframe displays being arranged in chronological order. The keyframe displays can be arranged in a rectangular array. Each keyframe display can be denoted by indicia (e.g., one or more numbers or letters, or a time and/or date) that identifies the keyframe display. The video content index display can further include a menu region that includes a multiplicity of page identification displays that each correspond to a page including a multiplicity of keyframe displays. Visual recording data representing the digital video content, and instructions and/or data for producing the video content index display can be encoded together on a data storage medium or media, such as one or more DVDs or CDs.

In yet another embodiment of the invention, a video content index display includes a keyframe display region that includes a multiplicity of keyframe displays, each keyframe display corresponding to a video segment of digital video content, and the keyframe displays being arranged in a rectangular array. Each keyframe display can be denoted by indicia (e.g., one or more numbers or letters, or a time and/or date) that identifies the keyframe display. The video content index display can further include a menu region that includes a multiplicity of page identification displays that each correspond to a page including a multiplicity of keyframe displays. Visual recording data representing the digital video content, and instructions and/or data for producing the video content index display can be encoded together on a data storage medium or media, such as one or more DVDs or CDs.

In another embodiment of the invention, navigation of digital video content (which can be stored on a video disk) is facilitated, by automatically evaluating the digital video content to identify a plurality of keyframes and automatically arranging the keyframes to be displayed as an index of the digital video content. In a further embodiment, a plurality of pages of keyframe displays are automatically identified for use in a video content index display produced on a visual display device. In another further embodiment, in which the digital video content is stored on a video disk, the keyframes are automatically arranged to be displayed as a keyframe index of a video disk package used to house the video disk when the video disk is not in use. In still another further embodiment, the plurality of keyframes is automatically modified to produce a new set of keyframes of a specified number. In yet another further embodiment, in which the digital video content is stored on a video disk, the video disk is automatically labelled with information identifying the digital video content.

### BRIEF DESCRIPTION OF THE DRAWINGS

FIG. 1 is a block diagram illustrating components of a system in which the invention can be used.

FIG. 2 illustrates a digital visual recording content index display according to the invention.

FIG. 3 illustrates a digital visual recording content index sheet, according to an embodiment of the invention, for use with a digital visual recording disk package.

FIG. 4 illustrates a subset of the keyframes of the digital visual recording content index sheet of FIG. 3.

FIG. 5 illustrates a digital visual recording disk labelled with identifying information in accordance with an embodiment of the invention.

### DETAILED DESCRIPTION OF THE INVENTION

In accordance with the invention, digital visual recording content is divided into a multiplicity of digital visual recording segments that are each represented by a digital visual recording frame (a keyframe). (As used herein, “frame” can refer to a visual image or to the data representing the image.) The collection of digital visual recording frames representing digital visual recording segments comprises an index of the digital visual recording content, each digital visual recording frame being an index entry. According to the invention, the digital visual recording content can be indexed in a manner that facilitates identification of the digital visual recording content and/or navigation through the digital visual recording content. The digital visual recording content can also be packaged in a manner that facilitates identification of the digital visual recording content and/or navigation through the digital visual recording content. The elements that facilitate identification of, and/or navigation through, the digital visual recording content (e.g., keyframes, pages of keyframes, video content index display and elements thereof, keyframe index to be presented on video disk package, identifying information for labelling the video disk) can be determined automatically, either from the digital visual recording content or from information provided by a person such as the author of the digital visual recording content.

The invention can be used with any digital visual recording content (e.g., digital video content). Herein, “visual recording content” refers to visual or audiovisual content that occurs over a period of time (such as a series of visual images acquired by a video camera or similar apparatus) or to the data representing such visual or audiovisual content. “Digital visual recording content” is visual recording content that is represented by digital data. For convenience (i.e., to make description of the invention less awkward), “video” is sometimes substituted herein for “visual recording;” the use of such term is not intended to limit the scope of the digital visual recording content with which the invention can be used. The digital visual recording content can be produced from analog visual recording content (e.g., an analog videotape). (“Analog visual recording content” is visual recording content that is represented by analog data.) For example, an analog videotape can be digitized and the digital data stored on one or more digital data storage media such as DVD(s) or CD(s). This can be done, for example, using the service provided for this purpose by YesVideo, Inc. of San Jose, Calif.

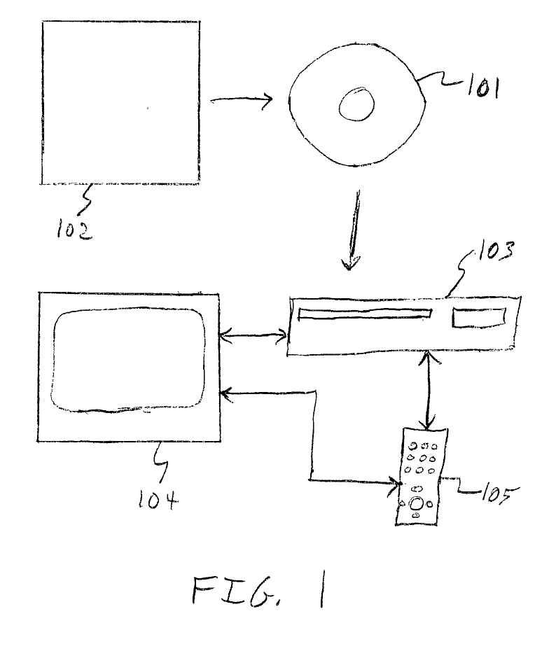

FIG. 1 is a block diagram illustrating components of a system in which the invention can be used. Digital video content is stored on a video disk 101. (Herein, for convenience, i.e., to make description of the invention less awkward, “video disk” is used to refer to any portable digital data storage medium or media.) When not in use, the video disk 101 is housed in a video disk package 102. To display the digital video content on the video disk 101, the video disk 101 is inserted into a playback device 103. Either automatically or in response to appropriate instruction effected by viewer action, the playback device 103 causes the digital video content stored on the video disk 101 to be displayed on a visual display device 104. A user control apparatus 105 is used to control operation of the playback device 103 and visual display device 104 to effect display of the digital video content in a desired manner. As described in more detail elsewhere herein, the user control apparatus 105 and/or the playback device 103 can also be used to cause a video content index display to be displayed by the visual display device 104 and to navigate through the digital video content using the video content index display. (If the user control apparatus 105 includes a visual display, the video content index display can also be displayed on the visual display of the user control apparatus 105.) The video disk 101, video disk package 102, playback device 103, visual display device 104 and user control apparatus 105 can be embodied by any appropriate apparatus. The video disk 101 can be embodied by any portable digital data storage medium or media, such as one or more DVDs, one or more CDs, or one or more digital videotapes. (Though the system described with respect to FIG. 1 includes a portable digital data storage medium, aspects of the invention—in particular, aspects of the invention related to the video content index display—can be used with digital video content stored on other types of digital data storage media, including those that may not be portable, such as a hard disk or digital memory, which can be part of, for example, a desktop computer or personal video recorder.) Further, the digital video content can be stored on the video disk 101 in any manner (e.g., in any format, such as DVD-R). The video disk package 102 can be embodied by, for example, a standard case used to contain a DVD or a CD. The playback device 103 can be embodied by, for example, a conventional DVD player, CD player, combination DVD/CD player, or computer including a CD and/or DVD drive. The visual display device 104 can be embodied by, for example, a television or a computer display monitor or screen. The user control apparatus 105 can be embodied by, for example, a remote control device (e.g., a conventional remote control device used to control a DVD player, CD player or combination DVD/CD player), control buttons on the playback device 103 and/or visual display device 104, or a mouse (or other pointing device).

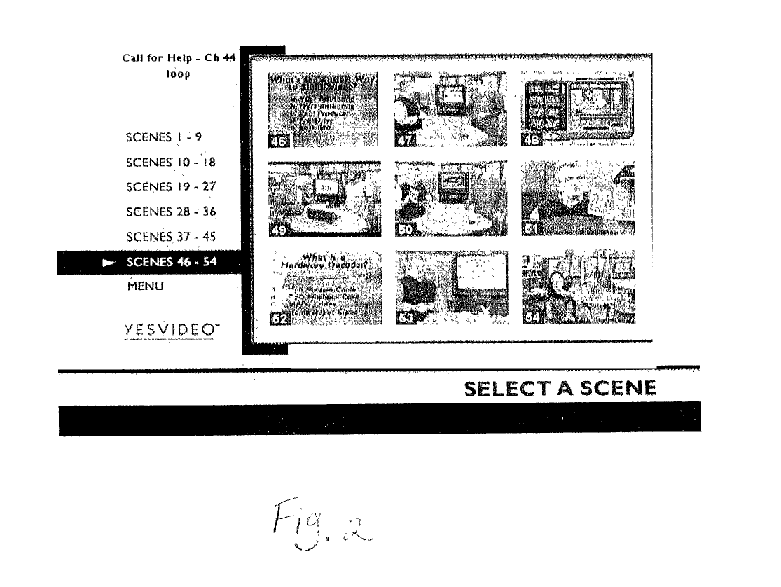

After the video disk 101 is inserted into the playback device 103, a “home” (or “root”) visual display can be produced on the visual display device 104 to enable a viewer to control operation of the playback device 103 and visual display device 104. The home visual display can be implemented to enable, for example, starting, stopping, pausing, rewinding and fast-forwarding of the display of digital video content. In particular, the home visual display can enable a viewer to access a video content index display that facilitates navigation through the digital video content (see FIG. 2 and associated description below). Alternatively, a video content index display is produced on the visual display device 104 immediately in response to insertion of the video disk 101 into the playback device 103.

The digital video content is divided into a multiplicity of video segments. Each video segment is a group of temporally contiguous video frames. The video segments can be of uniform or variable duration (typically the latter). For example, a DVD is typically divided into video segments called “chapters.” Each video segment can represent a “scene,” e.g., digital video content from a particular location. For example, a standard movie DVD defines a chapter for each scene in the movie script. In general, the video segments are defined so that the beginning of each video segment is a location in the digital video content to which a viewer would want to navigate to begin viewing digital video content. Typically, all of the digital video content in a video segment is related in a manner in which it is not related to the digital video content immediately preceding and succeeding the video segment, though this need not necessarily be the case. The invention can be used with predetermined video segments (i.e., video segments identified by a method not part of the invention) or the invention can be implemented to identify video segments (in particular, to automatically identify video segments). The video segments can be identified using any of a variety of methods. For example, the video segments can be identified by dividing the video content into a specified number of segments of uniform duration. The video segments can also be identified using any of a variety of scene detection methods. For example, scene detection as described in commonly-owned, co-pending U.S. patent application Ser. No. 09/792,280, entitled “Video Processing System Including Advanced Scene Break Detection Methods for Fades, Dissolves and Flashes,” filed on Feb. 23, 2001, by Michele Covell et al., the disclosure of which is hereby incorporated by reference herein, can be used with the invention.

Each of the video segments is represented by a video frame. Such a video frame is sometimes referred to herein as a “keyframe” (and can also be referred to as a “thumbnail”). The invention can be used with predetermined keyframes (i.e., keyframes identified by a method not part of the invention) or the invention can be implemented to identify keyframes (in particular, to automatically identify keyframes). The keyframes can be identified using any of a variety of methods. For example, a keyframe can be identified as the first (i.e., temporally earliest) video frame of a video segment. A keyframe can also be identified by evaluating the video content of the video segment and choosing as the keyframe a video frame of the video segment that is determined to be, based on the evaluation, representative of the video content of the video segment. For example, keyframes can be identified using a method as described in the above-referenced U.S. patent application Ser. No. 09/792,280, using a method as described in the commonly-owned, co-pending U.S. Provisional Patent Application Serial No. 60/306,282, entitled “Autosnap: A Method for Automatically Selecting Still Frames from Video,” filed on Jul. 17, 2001, by Michele Covell et al., or using a method as described in the commonly-owned, co-pending U.S. patent application entitled “Automatic Selection of a Visual Image or Images from a Collection of Visual Images, Based on an Evaluation of the Quality of the Visual Images,” filed by Michele Covell et al. on the same date as the present application and having attorney docket no. YES-006, the disclosures of each of which are hereby incorporated by reference herein.

The invention can be implemented so that video segments and keyframes are determined together. All of the video content is evaluated to identify keyframes. A video segment is defined as the video content beginning with one keyframe and ending just before the next subsequent keyframe. In such case, the invention can advantageously be implemented so that a specified number of keyframes are identified, as described further below.

The invention presents keyframe displays to a viewer in a manner that facilitates navigation through the digital video content by the viewer. In one aspect of the invention, keyframes are displayed on a visual display device. In another aspect of the invention, keyframes are displayed as part of a video disk package. The invention can be implemented to include either or both of these aspects. When both are implemented, these two aspects of the invention can be used separately or together to facilitate navigation through digital video content. In particular, the invention can be implemented so that the keyframe displays on a visual display device correspond to the keyframe displays that are part of a video disk package, which can advantageously facilitate a viewer's ability to quickly orient to available digital video content and navigate easily through that video content.

FIG. 2 illustrates a video content index display 200 according to the invention that is used to facilitate navigation through digital video content. The index display 200 includes a keyframe display region 201 and a menu region 202. As will be apparent from the description elsewhere herein, a video content index display in accordance with the invention can have other than the particular appearance illustrated in FIG. 2. As will also be apparent from the description elsewhere herein, a video content index display in accordance with the invention can advantageously be implemented in a manner that requires relatively few inputs by a viewer to a user control apparatus to enable navigation of digital video content. As will further be apparent from the description elsewhere herein, the elements of a video content index display in accordance with the invention (e.g., the keyframe display region 201 and menu region 202 of the video content index display 200 of FIG. 2) can advantageously be identified automatically from evaluation of the digital video content.

Data (and, as necessary or desirable, instructions, e.g., one or more computer programs) for creating a video content index display according to the invention can be stored on the video disk together with the digital video content. For example, this aspect of the invention can be implemented for use with digital video content stored on a DVD by making use of an industry standard DVD data structure to store data for use in creating a video content index display (e.g., by storing the data in an appropriate manner in tables in the DVD data structure, as can be appreciated by those skilled in the art).

The keyframe display region 201 includes a display of multiple keyframes. As illustrated in FIG. 2 (and discussed further below), the keyframe displays can be numbered. In general, the keyframe display region 201 can include a display of any number of keyframes greater than one. The keyframe displays can be arranged in a rectangular (e.g., square) array, as shown in FIG. 2. In FIG. 2, the keyframe display region 201 includes a 3×3 array of keyframe displays. However, other size arrays can be used, e.g., 2×2, 4×4, 2×3, etc. The number of keyframe displays in the keyframe display region 201 (e.g., the size of an array of keyframe displays) can depend on the size of the keyframe display region 201 (which can, in turn, depend on the size of the display screen on which the video content index display 200 is presented). For example, as the size of the keyframe display region 201 decreases, it can be increasingly desirable to decrease the number of keyframe displays in the keyframe display region 201 (e.g., size of the array of keyframe displays) so that an adequate size of each keyframe display can be maintained (e.g., large enough to enable the content of the keyframe display to be seen easily, large enough to enable use of a display resolution that does not produce artifacts, such as jagged edges, that are discernible to an undesirable degree). Conversely, as the size of the keyframe display region 201 increases, it can be increasingly desirable to increase the number of keyframe displays in the keyframe display region 201 (e.g., size of the array of keyframe displays) so that more video content selection possibilities are presented at one time.

The menu region 202 includes a display of an identification of “pages” (or “menus”) of keyframe displays. Each page includes multiple keyframe displays, typically (though not necessarily) the same number of keyframe displays that can be displayed at one time in the keyframe display region 201. The pages can be defined so that each page includes keyframe displays that are included in that page only. This is illustrated in FIG. 2, in which the menu region 202 includes a display of an identification of six pages: a first page including keyframe displays that represent scenes numbered 1 through 9, a second page including keyframe displays that represent scenes numbered 10 through 18, etc. The pages can also be defined so that the pages “overlap,” i.e., one or more of the keyframe displays of a page can be included in another page (e.g., a first page includes keyframe displays that represent scenes numbered 1 through 9, a second page includes keyframe displays that represent scenes numbered 4 through 12, a third page includes keyframe displays that represent scenes numbered 7 through 15, etc.

As indicated above, the keyframe displays can be numbered and the pages can be identified using numbering that corresponds to the numbering of the keyframe displays. In FIG. 2, a page including keyframe displays that represent scenes numbered 46 through 54 is displayed in the keyframe display region 201; each keyframe display is numbered with the number of the corresponding scene (i.e., numbers 46 through 54). The invention can also be implemented so that the keyframe displays are denoted by other indicia (e.g., letters, a time, a date, or a time and date) in addition to, or instead of, numbers. The use of corresponding numbers (or other indicia) for video segments and keyframes, and the use of those numbers in the identification of pages in the menu region 202 and keyframe displays in the keyframe display region 201 advantageously provides a readily identifiable and easily usable mechanism that can facilitate navigation through the digital video content in several ways, as will be appreciated from the description of the invention herein.

The keyframe displays and page identifications can be arranged in an ordered manner. For example, as discussed above, the keyframe displays in the keyframe display region 201 can be arranged in a rectangular array. Additionally, the keyframe displays and page identifications can be arranged in chronological order. For example, moving down or to the right through the keyframe displays of the keyframe display region 201 or through the page identifications of the menu region 202, the corresponding video segments represent digital video content that occurred later in time. (Note the arrangement of page identifications and keyframe displays in FIG. 2 in which the numbers associated with the keyframe displays increase in accordance with the chronological order of the corresponding video segments.) An ordered arrangement of the keyframe displays can further facilitate navigation through digital video content by enabling navigation through the video content in a systematic and logical manner, as will be appreciated from the description of the invention herein.

A user control apparatus is used to interact with the video content index display 200 to facilitate navigation through the digital video content. The user control apparatus can be used to highlight parts of the index display 200 (i.e., highlight a menu selection or a keyframe display) and select a part of the index display for further interaction (as described further below). Highlighting of a menu selection or a keyframe display, movement among the parts of the index display 200 to highlight different parts of the index display 200, and selection of a part of the index display 200 can be effected in any appropriate manner. For example, highlighting of a menu selection or a keyframe display can be effected by displaying a border around the item to be highlighted and/or by displaying an overlay which shades the item to be highlighted. Movement among the parts of the index display 200 to highlight different parts of the index display 200 can be effected using directional controls of a user control apparatus (e.g., the arrow key(s) commonly provided on remote control devices adapted for use with visual recording display apparatus, or, when the playback device and visual display device are implemented by a computer, the arrow keys and/or a “Tab” key of a computer keyboard, or movement of a computer mouse). Selection of a part of the index display 200 can be effected, for example, by depressing an “Enter,” “Action” or “Select” button (or similar button providing the same functionality) commonly provided on remote control devices for use with visual recording display apparatus, or, when the playback device and visual display device are implemented by a computer, using an “Enter” key of a computer keyboard or a specified input (e.g., a double-click) to a computer mouse.

The user control apparatus can be used to move between page identifications in the menu region 202 and select a page identification in the menu region 202. Selection of a page identification causes the display in the keyframe display region 201 of the keyframe displays corresponding to that page. The invention can be implemented so that selection of a page identification also automatically causes highlighting of a keyframe display (e.g., the center keyframe display in a 3×3 array of keyframe displays) in the keyframe display region 201.

The user control apparatus can also be used to move between keyframe displays in the keyframe display region 201 and select a keyframe display in the keyframe display region 201 as discussed above. Alternatively, if the user control apparatus includes a numeric keypad (as is typically the case with computer keyboards and the remote control devices used with visual recording display apparatus), a keyframe display can be selected using the numeric keypad to specify the number of the keyframe display. Selection of a keyframe display causes a display to begin of the video segment corresponding to that keyframe.

The invention can be implemented to enable movement to (i.e., highlighting of) a keyframe display that is not currently displayed in the keyframe display region 201, but that is adjacent to a keyframe display at the edge of the keyframe display region 201, without returning to the menu region 202 to highlight and select a new page identification including the new keyframe display. Such implementation of the invention can advantageously enable navigation among all of the keyframe displays of the digital video content (i.e., navigation through the entire digital video content) in a manner that requires relatively few inputs by a viewer to a user control apparatus (in particular, the entire digital video content can be navigated using only the arrow keys—or other directional control—of a user control apparatus). The invention can be implemented so that movement to the new keyframe display causes display in the keyframe display region 201 of an entirely new page of keyframe displays including the new keyframe display. Alternatively, when keyframe displays are arranged in a rectangular array, the invention can be implemented so that movement to the new keyframe display causes addition to the keyframe display region 201 of a new row or column (as appropriate) of keyframe displays including the new keyframe display and removal from the keyframe display region 201 of a corresponding row or column of keyframe displays at the opposite end of the keyframe display region 201. For example, in the implementation of the invention illustrated in FIG. 2, if keyframe display 47 is highlighted, the up arrow can be used to move to keyframe display 44. Upon such movement, the keyframe display region 202 can include, depending on the particular implementation, as discussed above, keyframe displays 37 through 45 or keyframe displays 43 through 51.

The invention can be implemented so that a specified input to a user control apparatus (e.g., activation of a “Menu” button on a remote control) during display of a video segment terminates display of the video segment, and causes display of the video content index display with a page displayed that includes the keyframe display corresponding to the video segment being displayed and with the keyframe display corresponding to the video segment being highlighted. Such implementation advantageously provides an easy way for a viewer to switch from viewing the digital video content to navigating through the digital video content. This implementation can also be used with digital video playback devices (“loop mode” playback devices) that are adapted to automatically begin displaying digital video content upon insertion of a video disk into the playback device and automatically continue displaying the video content over and over until the video disk is removed or an appropriate control instruction is received from a user control apparatus to terminate display of the video content. Loop mode playback can be implemented so that each re-display of the digital video content begins immediately after the conclusion of a previous display of the video content, or so that a pause of specified duration (e.g., 30 seconds) occurs prior to the beginning of each re-display of the video content. In the latter case, occurrence of the above-described specified input to a user control apparatus during the pause can cause display of the video content index display with a page displayed that includes the keyframe display corresponding to the first video segment of the digital video content and with the keyframe display corresponding to that video segment being highlighted.

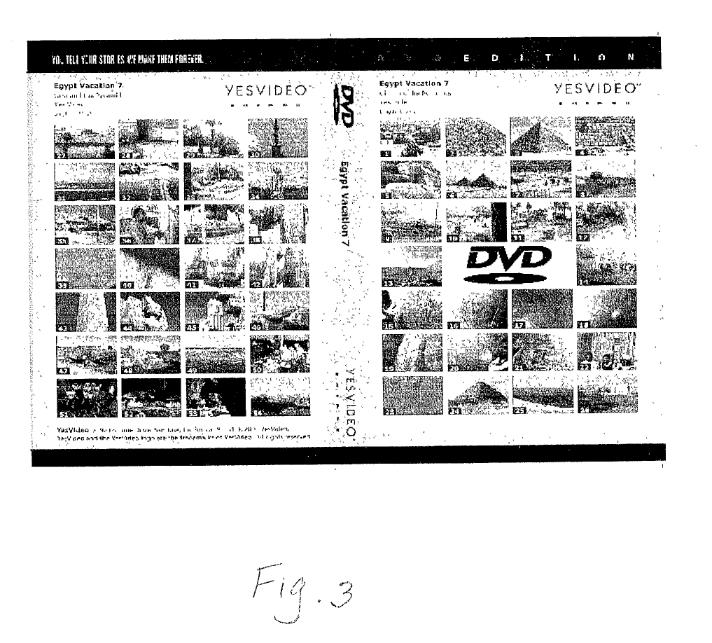

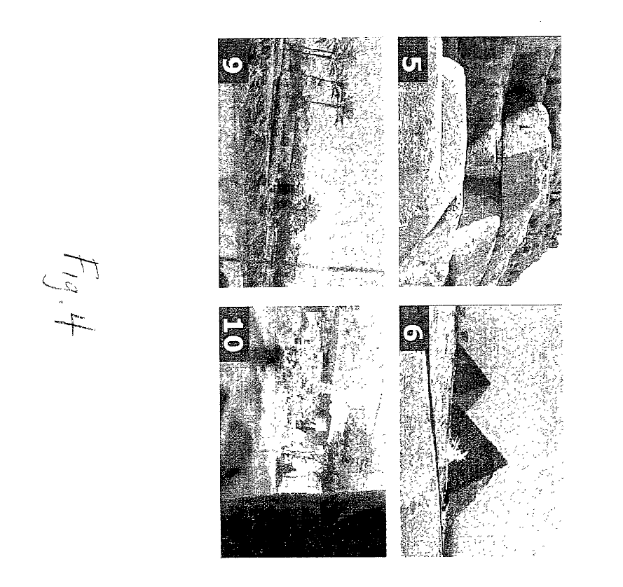

According to the invention, a video disk package for housing a video disk when not in use can be constituted in a manner that facilitates navigation through the digital video content stored on the video disk. In particular, a keyframe index can be formed as part of a video disk package. For example, the video disk package can include a keyframe index sheet which includes the keyframe displays for the digital video content stored on the video disk. FIG. 3 illustrates a keyframe index sheet according to an embodiment of the invention, while FIG. 4 illustrates a subset of the keyframe displays of the keyframe index sheet of FIG. 3. Alternatively, the keyframe index can be formed as part of a case used to house the video disk when not in use. Whether the keyframe index is formed on an index sheet or directly on a case, a video disk package including a keyframe index according to the invention can be constructed automatically, using the determination of keyframes and associated numbering, as discussed elsewhere herein. Each of the keyframe displays of the keyframe index of the video disk package can advantageously be numbered using the same numbers as used to number the keyframe displays of the video content index display for that digital video content. Thus, a viewer can navigate through the digital video content using only the video disk package. For example, a viewer can, using the video disk package including a keyframe index, directly select a video segment for display using a numeric keypad of a user control apparatus. Additionally, correspondence between the numbering of the keyframe displays of the keyframe index of the video disk package and that of the keyframe displays of the video content index display enables the keyframe index of the video disk package to provide context for the keyframe displays of the video content index display, since more keyframe displays can be included as part of the keyframe index of the video disk package than can be included as part of the video content index display. Thus, the ability of a viewer to rapidly assimilate and acclimate to the available digital video content is enhanced.

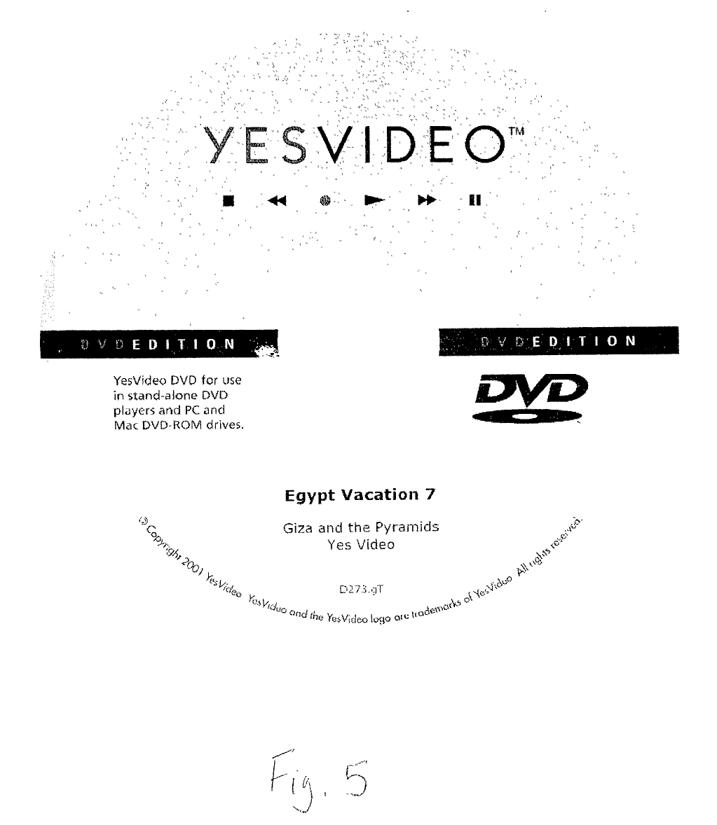

According to the invention, a video disk can be labelled with information that identifies the digital video content stored on the video disk and/or information related to the video content, thus facilitating a viewer's ability to identify the nature of the video content and perhaps facilitating navigation of the video content by the viewer (e.g., knowledge of the nature of the digital video content may enable a viewer to have a good idea of where particular video content of interest is located, such as near the beginning or near the end of the video content). For example, a video disk can be labelled with a title, a description of the digital video content, a name of the author of the video content (i.e., the person or entity who acquired, or caused to be acquired, the video content) and/or the date of acquisition of the video content. FIG. 5 illustrates a video disk labelled with identifying information in accordance with an embodiment of the invention: the title of the digital video content is Egypt Vacation 7, the description of the digital video content is “Giza and the Pyramids” and the author of the digital video content is “YesVideo.” Information to be included in the video disk label can be obtained automatically. For example, when the video disk is produced by digitizing the video content stored on an analog videotape, the date of acquisition of the video content is often stored on the videotape and can be automatically obtained from the videotape. Information to be included in the video disk label can also be obtained manually from a person (e.g., the author of the digital video content, a customer of a commercial video digitizing service). For example, when the video disk is produced by a commercial video digitizing service that digitizes the video content stored on an analog videotape and stores the digitized video content on the video disk, information such as title, description and author can be provided by a customer at the videotape drop-off location, e.g., via a self-service terminal or to a clerk (who can then enter the information into a computer or other electronic data processing system). Further, in the case where a commercial service produces a video disk from an analog videotape, once obtained (whether automatically from the videotape, via a clerk or via a self service terminal), the identifying information can be handled automatically (electronically), without further human intervention, to label the video disk.

It can be desirable to implement the invention so that a specified number of video segments are defined, and corresponding keyframes identified, in the digital video content. This can be desirable, for example, to establish a number of video segments and corresponding keyframes that will produce a keyframe index including a number of keyframe displays that will fit in a desired fashion (e.g., in specified space(s), with keyframe displays of adequate size) on a video disk package (or on an index sheet of a video disk package). (See, for example, FIG. 3, discussed above, in which the layout of a keyframe index sheet according to an embodiment of the invention includes space for 54 keyframe displays.) Similarly, this can be desirable to establish a number of video segments and corresponding keyframes that will produce a keyframe index including a number of keyframe displays that will “fit” in a desired fashion (e.g., to fill a specified number of non overlapping pages of keyframe displays of a specified array size) in a video content index display. (See, for example, FIG. 2, discussed above, in which the video content index display 200 includes a menu region 202 with space for six page identifications and a keyframe display region 201 with space for a 3×3 array of keyframe displays.)

However, it will often be the case that an initial number of video segments and corresponding keyframes in the digital video content is different from the specified number. For example, the number of video segments identified by a scene detection method (and, implicitly, the number of keyframes), such as described in the above-referenced U.S. patent application Ser. No. 09/792,280, can be different from the specified number. Similarly, the number of keyframes identified by a keyframe identification method (and, implicitly, the number of video segments), such as described in the above-referenced U.S. patent application Ser. No. 09/792,280, U.S. Provisional Patent Application Serial No. 60/306,282 and U.S. patent application having attorney docket no. YES-006, can be different from the specified number.

The invention can be implemented so that an initial number of video segments and corresponding keyframes is modified to produce a specified number, n, of video segments and corresponding keyframes. The invention can be implemented to eliminate video segments and corresponding keyframes when the initial number of video segments and corresponding keyframes is too large (if the initial number is too small, the initial number is maintained), add video segments and corresponding keyframes when the initial number of video segments and corresponding keyframes is too small (if the initial number is too large, the initial number is maintained), or, as necessary, either eliminate or add video segments and corresponding keyframes. Further, the invention can advantageously be implemented so that, if the specified number of video segments and corresponding keyframes has been previously indicated, the modification of the initial number of video segments and corresponding keyframes is done automatically, if necessary, after the initial video segments and corresponding keyframes are ascertained.

For example, to enable elimination or addition of video segments and corresponding keyframes, all of the video frames of the digital video content can be evaluated and a score determined for each video frame based on one or more criteria intended to identify representative video frames, the n video frames having the highest scores then being selected as keyframes (the video segments being defined implicitly as the digital video content beginning with one keyframe and ending just before the next subsequent keyframe). This can be done using, for example, a method as described in the above-referenced U.S. Provisional Patent Application Serial No. 60/306,282 and U.S. patent application having attorney docket no. YES-006.

To add one or more video segments and corresponding keyframes when the initial number of video segments and corresponding keyframes is smaller than the specified number, one or more video segments can be divided in a specified manner. For example, video segments can be split in half (or at some other specified point in a video segment) until the specified number of video segments is produced (for example, starting with the longest video segment and splitting each successive next longest video segment). A keyframe must be determined for at least one of the new video segments created by dividing a video segment, and, depending upon, for example, the manner in which the keyframe was determined for the original video segment (which may enable knowledge of which of the two new video segments contain the keyframe determined for the original video segment), may need to be determined for the other new video segment as well. (Keyframes can be determined as discussed in more detail above.) This approach can be used, in particular, when the digital video content is known to be relatively static.

Alternatively or additionally, to add one or more video segments and corresponding keyframes when the initial number of video segments and corresponding keyframes is smaller than the specified number, the video frames of one or more video segments can be evaluated and the video frame(s) being the most different from the immediately previous video frame(s) determined to be a new keyframe (the digital video content beginning with the new keyframe and ending just before the next subsequent keyframe being identified implicitly as the corresponding new video segment). A variety of methods for identifying visual differences in adjacent video frames are known to those skilled in the art and can be used with the invention. For example, visual differences in adjacent video frames can be identified by calculating the Average Magnitude Difference Function (AMDF) between the spatially corresponding pixels in adjacent video frames (the difference in either or both the luminance and chrominance values can be calculated).

Or, alternatively or additionally, to add one or more video segments and corresponding keyframes when the initial number of video segments and corresponding keyframes is smaller than the specified number, audio content corresponding to the video frames of one or more video segments can be evaluated for the presence of one or more cues that likely correspond to a transition in the digital video content. If, for a video frame, such cue(s) are determined to be present with greater than a specified likelihood, then the video frame is identified as a new keyframe (the digital video content beginning with the new keyframe and ending just before the next subsequent keyframe being identified implicitly as the corresponding new video segment). A variety of methods for identifying audio cues are known to those skilled in the art and can be used with the invention. For example, analysis of the audio energy envelope can be used to detect speaker pauses by detecting audio energy that drops below a specified threshold for a specified length of time, or to detect applause by comparing the audio energy envelope with characteristic audio energy decay time patterns. Or, for example, analysis of the audio frequency spectrum can be used to detect a change in speaker identity, where the audio was recorded (by, for example, matching the audio frequency spectrum to the reverberation characteristics of a room), or other change in signatures derived from the audio signal.

To eliminate one or more video segments and corresponding keyframes when the initial number of video segments and corresponding keyframes is greater than the specified number, the temporal spacing between each pair of original keyframes can be evaluated and the n keyframe(s) that are determined to have the highest average temporal spacing from the adjacent pair of keyframes are retained as keyframes (the video segments are identified implicitly as digital video content beginning with a keyframe of the retained keyframes and ending just before the next subsequent keyframe of the retained keyframes).

Alternatively or additionally, to eliminate one or more video segments and corresponding keyframes when the initial number of video segments and corresponding keyframes is greater than the specified number, the visual difference between each pair of original keyframes can be evaluated and the n keyframe(s) that are determined to have the highest average visual difference from the adjacent pair of keyframes are retained as keyframes (the video segments are identified implicitly as digital video content beginning with a keyframe of the retained keyframes and ending just before the next subsequent keyframe of the retained keyframes). A variety of methods for identifying visual differences in video frames are known to those skilled in the art and can be used with the invention. For example, visual differences in video frames can be identified by calculating the Average Magnitude Difference Function (AMDF) between the spatially corresponding pixels in adjacent video frames, as discussed above.

A video content index display may be produced on a visual display device by interlacing. Refreshing an interlaced visual display can result in the appearance of shimmer (or twitter) in the images of the visual display, in particular, at locations of horizontal edges that deviate sufficiently from horizontal. To reduce or eliminate the appearance of shimmer in a video content index display produced by interlacing, the invention can be implemented so that an anti-shimmer filter method (any of a variety of anti-shimmer filter methods known to those skilled in the art can be used) is used to process the image data representing the video content index display before use of that image data to generate the video content index display.

The invention can be implemented, for example, by one or more computer programs and/or data structures including instruction(s) and/or data for accomplishing the functions of the invention. For example, such computer program(s) and/or data structures can include instruction(s) and/or data for identifying video segments, identifying keyframes, modifying an initial determination of video segments and corresponding keyframes, creating a video content index display, processing a video content index display to reduce or eliminate shimmer, forming a video content index as part of a video disk package, and/or labelling a video disk with identifying information. Those skilled in the art can readily implement the invention using one or more computer program(s) and/or data structures in view of the description herein.

Various embodiments of the invention have been described. The descriptions are intended to be illustrative, not limitative. Thus, it will be apparent to one skilled in the art that certain modifications may be made to the invention as described herein without departing from the scope of the claims set out below.

We claim:

1. A data storage medium or media encoded with instructions and/or data for producing a video content index display, the video content index display comprising a keyframe display region including a plurality of keyframe displays, each keyframe display corresponding to a video segment of digital video content, wherein each keyframe display is denoted by indicia that identifies the keyframe display and the corresponding video segment.

2. A data storage medium or media as in claim 1, wherein the indicia comprises a number.

3. A data storage medium or media as in claim 1, wherein the indicia comprises a time and/or date.

4. A data storage medium or media as in claim 1, wherein each of the indicia denoting a keyframe display indicates a corresponding input to a user control apparatus that begins display on a visual display device of the video segment corresponding to the keyframe display.

5. A data storage medium or media as in claim 1, wherein the video content index display further comprises a menu region including a plurality of page identification displays, each page identification display identifying a page of keyframe displays.

6. A data storage medium or media as in claim 1, encoded with visual recording data representing the digital video content.

7. A data storage medium or media as in claim 1, wherein the data storage medium or media comprises one or more DVDs.

8. A data storage medium or media as in claim 1, herein the data storage medium or media comprises one or more CDs.

9. A video disk package for housing a video disk when the video disk is not in use, the video disk package comprising a keyframe index including a plurality of keyframe displays, each keyframe display corresponding to a video segment of digital video content, wherein each keyframe display is denoted by indicia that identifies the keyframe display and the corresponding video segment.

10. A video disk package as in claim 9, wherein the indicia comprises a number.

11. A data storage medium or media as in claim 9, wherein the indicia comprises a time and/or date.

12. A data storage medium or media as in claim 9, wherein each of the indicia denoting a keyframe display indicates a corresponding input to a user control apparatus that begins display on a visual display device of the video segment corresponding to the keyframe display.

13. A video disk package as in claim 9, wherein the keyframe index is formed on a keyframe index sheet.

14. A video disk package as in claim 9, wherein the keyframe index is formed as part of a case used to house the video disk when not in use.

15. A video disk package as in claim 9, wherein the video disk is encoded with visual recording data representing the digital video content.

16. A video disk package as in claim 9, wherein the video disk comprises one or more DVDs.

17. A video disk package as in claim 9, wherein the video disk comprises one or more CDs.

18. A system for facilitating navigation of digital video content, comprising:
a data storage medium or media encoded with instructions and/or data for producing a video content index display, the video content index display comprising a keyframe display region including a plurality of keyframe displays, wherein each keyframe display is denoted in the video content index display by indicia that identifies the keyframe display; and
a video disk package for housing a video disk when the video disk is not in use, the video disk package comprising a keyframe index including a plurality of keyframe displays, wherein each keyframe display is denoted in the video disk package keyframe index by the same indicia used to denote that keyframe display in the video content index display.

19. A system as in claim 18, wherein:
each keyframe display corresponds to a video segment of the digital video content; and
each of the indicia denoting a keyframe display indicates the video segment.

20. A system as in claim 18, wherein the indicia comprises a number.

21. A system as in claim 18, wherein the indicia comprises a time and/or date.

22. A system as in claim 18, wherein each of the indicia denoting a keyframe display indicates a corresponding input to a user control apparatus that begins display on a visual display device of the video segment corresponding to the keyframe display.

23. A system as in claim 18, wherein the video content index display further comprises a menu region including a plurality of page identification displays, each page identification display identifying a page of keyframe displays.

24. A system as in claim 18, wherein the keyframe index is formed on a keyframe index sheet.

25. A system as in claim 18, wherein the keyframe index is formed as part of a case used to house the video disk when not in use.

26. A system as in claim 18, wherein the data storage medium or media is the video disk, which is also encoded with visual recording data representing the digital video content.

27. A system as in claim 18, wherein the video disk comprises one or more DVDs.

28. A system as in claim 18, wherein the video disk comprises one or more CDs.

29. A method for identifying video segments and corresponding keyframes in digital video content, comprising the steps of:
ascertaining a specified number of video segments and corresponding keyframes to be identified in the digital video content; and
modifying a previously determined set of video segments and corresponding keyframes in the digital video content to produce a new set of video segments and corresponding keyframes in the digital video content, such that the new set of video segments and corresponding keyframes comprises the specified number of video segments and corresponding keyframes.

30. A method as in claim 29, wherein the step of modifying further comprises the step of adding one or more video segments and corresponding keyframes to the previously determined set of video segments and corresponding keyframes.

31. A method as in claim 29, wherein the step of modifying further comprises the step of eliminating one or more video segments and corresponding keyframes from the previously determined set of video segments and corresponding keyframes.

32. A method as in claim 29, wherein the digital video content is stored on a video disk, the method further comprising the step of creating a keyframe index for inclusion as part of a video disk package for housing the video disk when the video disk is not in use, the keyframe index including keyframe displays produced from the new set of keyframes.

33. A method as in claim 29, further comprising the step of grouping the new set of keyframes in a plurality of pages, each page including a plurality of keyframes, none of which are included in another page.

34. A method as in claim 29, wherein the step of modifying is performed automatically after determination of the previously determined set of video segments and corresponding keyframes.

35. A method as in claim 29, wherein the digital video content is stored on a video disk.

36. A method for facilitating navigation of digital video content, wherein a plurality of keyframes have been defined that each correspond to a video segment of the digital video content, the method comprising the steps of:
displaying a first plurality of keyframe displays;
ascertaining an input to a user control apparatus intended to effect movement of the position of a highlighting display mechanism from a keyframe display located at an edge of the first plurality of keyframe displays; and
displaying a second plurality of keyframe displays in response to the input, wherein the second plurality of keyframe displays includes one or more keyframe displays not included in the first plurality of keyframe displays.

37. A method as in claim 36, wherein none of the keyframe displays of the second plurality of keyframe displays is included in the first plurality of keyframe displays.

38. A method as in claim 36, wherein:
at least one of the keyframe displays of the first plurality of keyframe displays is included in the second plurality of keyframe displays; and
at least one of the keyframe displays of the second plurality of keyframe displays is not included in the first plurality of keyframe displays.

39. A method as in claim 36, wherein the first plurality of keyframe displays is arranged in a rectangular array.

40. A method as in claim 36, wherein the digital video content is stored on a video disk.

41. A video content index display for use in navigating digital video content, the video content index display comprising a keyframe display region including a plurality of keyframe displays each corresponding to a video segment of the digital video content, wherein the keyframe displays are arranged in chronological order.

42. A video content index display as in claim 41, wherein the keyframe displays are arranged in a rectangular array.

43. A video content index display as in claim 41, wherein each keyframe display is denoted by indicia that identifies the keyframe display.

44. A video content index display as in claim 41, the video content index display further comprising a menu region including a plurality of page identification displays, each page identification display corresponding to a page including a plurality of keyframe displays.

45. A video content index display as in claim 41, wherein a data storage medium or media is encoded with visual recording data representing the digital video content, and instructions and/or data for producing the video content index display.

46. A video content index display for use in navigating digital video content, the video content index display comprising a keyframe display region including a plurality of keyframe displays each corresponding to a video segment of the digital video content, wherein the keyframe displays are arranged in a rectangular array.

47. A video content index display as in claim 46, wherein each keyframe display is denoted by indicia that identifies the keyframe display.

48. A video content index display as in claim 46, the video content index display further comprising a menu region including a plurality of page identification displays, each page identification display corresponding to a page including a plurality of keyframe displays.

49. A video content index display as in claim 46, wherein a data storage medium or media is encoded with visual recording data representing the digital video content, and instructions and/or data for producing the video content index display.

50. A method for facilitating navigation of digital video content, comprising the steps of:
automatically evaluating the digital video content to identify a plurality of keyframes; and
automatically arranging the keyframes to be displayed as an index of the digital video content.

51. A method as in claim 50, further comprising the step of automatically identifying a plurality of pages of keyframe displays to be used in a video content index display produced on a visual display device.

52. A method as in claim 50, wherein:
the digital video content is stored on a video disk; and
the step of automatically arranging the keyframes further comprises the step of automatically arranging the keyframes to be displayed as a keyframe index of a video disk package used to house the video disk when the video disk is not in use.

53. A method as in claim 50, further comprising the step of automatically modifying the plurality of keyframes to produce a new set of keyframes of a specified number.

54. A method as in claim 50, wherein the digital video content is stored on a video disk, the method further comprising the step of automatically labelling the video disk with information identifying the digital video content.

55. A method as in claim 50, wherein the digital video content is stored on a video disk.
